(19) United States
(12) Patent Application Publication
(10) Pub. No.: US 2026/0148154 A1
(43) Pub. Date: May 28, 2026

(54) HOW TO RECOMMEND DEPARTMENTS THROUGH PERSONAL COMPETENCY ANALYSIS

(71) Applicant: MAJOR MAP CO., LTD, Incheon (KR)

(72) Inventor: Joong Hoon LEE, Seoul (KR)

(73) Assignee: MAJOR MAP CO., LTD, Incheon (KR)

(21) Appl. No.: 19/207,543

(22) Filed: May 14, 2025

(30) Foreign Application Priority Data
Nov. 28, 2024 (KR) 10-2024-0173420

(51) Int. Cl. G06Q 10/0631

(52) U.S. Cl. CPC G06Q 10/063112

(57) ABSTRACT

A method of recommending a department through personal competency analysis, includes: a first operation of, by the platform server, collecting department information data; a second operation of receiving personal competency information; a third operation of generating at least one piece of university recommended department information by comparing the department information analysis data stored in the first operation with the personal competency information input by the user in the second operation; a fourth operation of illustrating and providing, to the user terminal, a diagram of a correlation between a plurality of recommended departments; a fifth operation of generating comparative analysis data corresponding to a resultant value of comparing the department information analysis data; and a sixth operation of generating admission prediction data by comparing the comparative analysis data analyzed in the fifth operation with admission data of university admitted students.

### CROSS REFERENCE TO RELATED APPLICATION

The present application claims the benefit of Korean Patent Application No. 10-2024-0173420 filed in the Korean Intellectual Property Office on Nov. 28, 2024, the entire contents of which are incorporated herein by reference.

### BACKGROUND OF THE DISCLOSURE

The present disclosure relates to a method of recommending a department through personal competency analysis, and more in detail, to a method of recommending a department through personal competency analysis to enable to decide on an admission path through personal competency and interest in accordance with admission to high schools or universities.

Recently, as various specialized high schools and special-purpose high schools have been established in high school curricula and various departments have been introduced to the specialized high schools, respective schools and departments have been imposing various admission requirements to select students. In addition to written examinations, these admission requirements take into account various matters that may be derived from student record information, such as grades for each subject, attendance, volunteer activities, awards and punishments, participation in special activities, and creative experiential activities.

However, admission guidelines published by each school do not provide the admission requirements in a standardized format. Consequently, admission candidates, i.e., prospective students, and admission guidance teachers face difficulties in obtaining and understanding diverse admission requirements according to different schools and departments.

Meanwhile, student record information of students is centrally managed by a computer network operated by each local education office. Regulations for calculating grades required for admission to each school and each department based on the student record information are frequently revised and published. Therefore, it is desirable to automatically provide students with information of schools or departments such that the students meet admission requirements or have a high likelihood of being accepted, based on the student record information, the regulations for calculating grades, and the admission guidelines published in various formats by each school.

Recently, with emergence of an admissions officer system, not only prospective students'grades, official test scores, student records, and written test scores, but also qualitative factors such as extracurricular activities, teacher recommendations, and awards have become factors in evaluating students.

In addition, one of important matters evaluated in the admissions officer system is a personal statement. The personal statement functions to provide various appealing information such as a growth process, strengths and weaknesses, motivations, and aspirations of a student to personnel in charge of admissions, e.g., an admissions officer of a school to which the student is applying for.

Thus, the personnel in charge of admissions such as an admissions officer evaluate not only quantitative factors such as grades, official test scores, and student records of a prospective student, etc., but also qualitative factors such as extracurricular activities, teacher recommendations, awards, personal statements, etc. to determine whether the prospective student is suitable for school.

As described above, not only for admissions to middle school or high school but also for college admissions, parents and students are spending a lot of time preparing and planning career paths, and incur a burden of paying high consulting fees to external consulting agencies for admissions counseling.

In addition, prospective students place a greatest weight on selecting a major when choosing a career path. Although the prospective students make a selection intuitively based on aptitude and competencies or with a help of consulting firms, there are limitations in analyzing exact aptitude, interests, and personal competencies of the prospective students. In a case of consulting firms, consulting services are based on experiences of consultants and collected data, and thus, depend on individuals'capabilities, resulting in low accuracy.

In addition, during an admission preparation process, a series of processes of selecting and changing a career path and meeting competency requirements needs to be systematically performed in real time based on competency of students. However, there is a problem in that many challenges are present in reality.

### PRIOR ART DOCUMENTS

### Patent Documents

(Patent document 1) Korea Patent No. 10-2016-0072629
(Patent document 2) Korea Patent No. 10-2019-0080100
(Patent document 3) Korea Patent No. 10-2019-0098376
(Patent document 4) Korea Patent No. 10-2020-0071878

### SUMMARY OF THE DISCLOSURE

Accordingly, the present disclosure has been made in view of the above-mentioned problems occurring in the related art, and it is an object of the present disclosure to provide a department recommendation service capable of, with respect to department selection for admission to middle or high schools or universities, allowing to select a career direction with high satisfaction through competency analysis by analyzing customized information such as competency, interests, and a desired career path of a prospective student and recommending department information aligned with career or major suitability.

In addition, it is an object of the present disclosure to provide data that may be easily checked at one view to make accurate decisions in choosing a career path by providing information in accordance with various major career decision factors for corresponding departments, as well as department information, to prospective students who are contemplating career paths.

In addition, it is an object of the present disclosure to provide a system configured to collect admission data regarding major selections and college admissions of past prospective students in advance and, based on this, provide a user with admission prediction data to help the user to determine an admission direction.

To accomplish the above-mentioned objects, according to one aspect of the present disclosure, there is provided a method of recommending a department through a department recommendation system configured to include: a platform server configured to generate department information analysis data through machine learning after collecting department information of a plurality of university institutions, analyze personal competency information of a user by comparing the department information analysis data with the personal competency information input by the user, generate and provide recommended department information based on the personal competency information, and generate desired competency information by comparing the personal competency information of the user and the department information analysis data; a university server configured to provide department information data including department information and department course information of a corresponding university to allow the platform server to collect the department information; and a user terminal configured to receive, from the user, an input of the personal competency information of the user to provide the personal competency information to the platform server, the method including: a first operation of, by the platform server, collecting department information data including department information and department course information from the plurality of the university institutions, and generating and storing department information analysis data through machine learning; a second operation of receiving personal competency information including certification information and extracurricular activity information, the personal competency information being input by the user through the user terminal; a third operation of generating at least one piece of university recommended department information by comparing the department information analysis data stored in the first operation with the personal competency information input by the user in the second operation; a fourth operation of illustrating and providing, to the user terminal, a diagram of a correlation between a plurality of recommended departments based on the at least one piece of university recommended department information generated for the user in the third operation; a fifth operation of, when one department among the plurality of recommended departments in the fourth operation is selected, generating comparative analysis data corresponding to a resultant value of comparing the department information analysis data corresponding to the selected department with the personal competency information of the user; and a sixth operation of generating admission prediction data by comparing the comparative analysis data analyzed in the fifth operation with admission data of university admitted students, the admission data being stored in the platform server, and then, providing the generated admission prediction data to the user terminal.

With respect to the admission prediction data, personal competency information corresponding to existing university admission, and information about desired departments, accepted departments, and selected departments may be generated and provided to the user terminal.

In the present disclosure configured and operated as described above, there is such an advantage that, to promote efficient selection of departments for admission to middle schools, high schools, or universities by prospective students, customized information such as competencies, interests, and desired career paths of the prospective students may be analyzed and department information that aligns with career or major suitability may be recommended, thereby allowing the prospective students to efficiently select career directions with high satisfaction through the competency analysis.

In addition, the present disclosure has an effect of visualizing similarity information of department information for respective schools, thereby allowing prospective students to easily check the similarity information and plan admission strategies accordingly.

Particularly, the present disclosure has an advantage of providing admission prediction data of a user based on admission data, resultantly allowing to determine an optimized direction for admission.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a flowchart of a method of recommending a department through personal competency analysis according to the present disclosure;

FIG. 2 is a flowchart illustrating another embodiment of a method of recommending a department through personal competency analysis according to the present disclosure;

FIG. 3 is a whole configuration diagram of a system configured to recommend a department through personal competency analysis according to the present disclosure;

FIG. 4 is a diagram illustrating a correlation between departments as an embodiment of the method of recommending a department through personal competency analysis according to the present disclosure;

FIG. 5 is a diagram illustrating a correlation between departments for respective schools in the method of recommending a department through personal competency analysis according to the present disclosure; and

FIG. 6 illustrates an example of admission prediction data in the method of recommending a department through personal competency analysis according to the present disclosure.

### DETAILED DESCRIPTION OF THE PREFERRED EMBODIMENT

Hereinafter, a method of recommending a department through personal competency analysis according to the present disclosure will be described in detail with reference to the attached drawings.

In this specification, the term ‘unit’ includes a unit implemented by hardware, a unit implemented by software, and a unit realized using both. Additionally, one unit may be implemented using two or more pieces of hardware, or two or more units may be implemented using one piece of hardware. Meanwhile, a ‘unit’ is not limited to hardware or software, and a “unit” may be configured to be included in a storage medium that may be addressed, or configured to play one or more processors. Accordingly, as an example, a ‘unit’ includes components such as software components, object-oriented software components, class components, or task components, processes, functions, attributes, procedures, subroutines, segments of a program code, drivers, firmware, micro-codes, circuits, data, database, data structures, tables, arrays, or variables. Functions provided in components or ‘units’ may be combined into a small number of components or ‘units,’ or separated into additional components or ‘units.’ In addition, the components and ‘units’ may be implemented to play one or more CPUs within a device or a secure multimedia card.

The “terminal” described hereinafter may be implemented as a computer or a portable terminal capable of being connected to a server or other terminal via a network. Here, the computer may include, for example, a notebook computer, a desktop computer, a laptop computer, a virtual reality head-mounted display (VR HMD) (e.g., HTC VIVE, Oculus Rift, GearVR, DayDream, PlayStation VR (PSVR), etc.) equipped with a web browser.

In addition, a “network” means a connection structure that enables information exchange between respective nodes, such as terminals and servers, and includes a local area network (LAN). a wide area Network (WAN), the Internet (WWW: world wide web), a wired and wireless data communication network, a telephone network, a wired and wireless television communication network, etc. Examples of wireless data communication networks include 3G, 4G, 5G, 3rd generation partnership project (3GPP), long term evolution (LTE), world interoperability for microwave access (WIMAX), Wi-Fi, Bluetooth communication, infrared communication, ultrasonic communication, and visible light communication (VLC), light fidelity (LiFi), etc., but is not limited thereto.

A method of recommending a department through personal competency analysis according to the present disclosure is performed through a department recommendation system configured to include: a platform server configured to generate department information analysis data through machine learning after collecting department information of a plurality of university institutions, analyze personal competency information of a user by comparing the department information analysis data with the personal competency information input by the user, generate and provide recommended department information based on the personal competency information, and generate desired competency information by comparing the personal competency information of the user and the department information analysis data; a university server configured to provide department information data including department information and department course information of a corresponding university to allow the platform server to collect the department information; and a user terminal configured to receive, from the user, an input of the personal competency information of the user to provide the personal competency information to the platform server. The method may include: a first operation of, by the platform server, collecting department information data including department information and department course information from the plurality of the university institutions, and generating and storing department information analysis data through machine learning; a second operation of receiving personal competency information including certification information and extracurricular activity information, the personal competency information being input by the user through the user terminal; a third operation of generating at least one piece of university recommended department information by comparing the department information analysis data stored in the first operation with the personal competency information input by the user in the second operation; a fourth operation of illustrating and providing, to the user terminal, a diagram of a correlation between a plurality of recommended departments based on the at least one piece of university recommended department information generated for the user in the third operation; a fifth operation of, when one department among the plurality of recommended departments in the fourth operation is selected, generating comparative analysis data corresponding to a resultant value of comparing the department information analysis data corresponding to the selected department with the personal competency information of the user; and a sixth operation of generating admission prediction data by comparing the comparative analysis data analyzed in the fifth operation with admission data of university admitted students, the admission data being stored in the platform server, and then, providing the generated admission prediction data to the user terminal.

The method of recommending a department through personal competency analysis according to the present disclosure has a main technical point of providing a department recommendation service method capable of allowing prospective students who are preparing for admission to universities to make a right choice for admission on basis of information such as interests, tendencies, and personal competencies of the prospective students and, based on this, monitor, check, and select detailed information about educational admission institutions.

Particularly, the present disclosure provides a department recommendation method of collecting admission data regarding previously admitted students and, based on this, generating and providing admission prediction data according to user information to greatly help to make an admission decision.

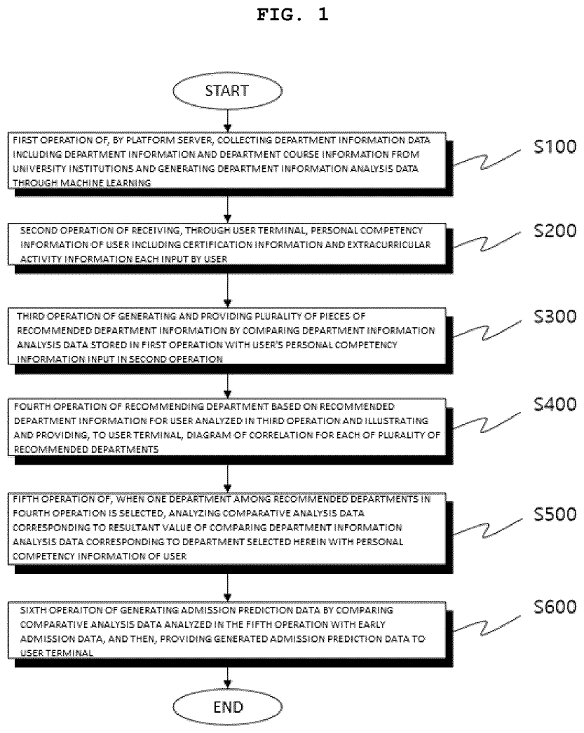

FIG. 1 is a flowchart of a method of recommending a department through personal competency analysis according to the present disclosure.

The department recommendation service method according to the present disclosure includes collecting and providing information about curricula (departments, majors, courses, etc.) of various educational institutions to offer users (or prospective students) information about majors that align with interests and tendencies of the users to promote right career choices. Here, the educational institutions may generally correspond to universities, and all services capable of providing all department information needed for admission to middle schools or high schools such as special-purpose high schools or universities are included.

First, the present disclosure provides a first operation (S100) of, by the platform server, collecting department information data including department information, introduction information of the department information, and department course information from a plurality of educational institutions, and generating and storing department information analysis data through machine learning.

Here, the department information analysis data includes department information of a corresponding educational institution, major information in one department, and all information related to the corresponding department, including relevant professor information, thesis information, and examination information, etc. With respect to this, the platform server according to the present disclosure collects and analyzes relevant information from a corresponding institution based on language. At this time, the department information is collected and analyzed based on language through analysis machine learning configured in the platform server to be collected, classified, and stored through main keywords, similarity keywords, etc.

Accordingly, in the present disclosure, the department information analysis data is collected, and then, based on this, department information needed for an admission process for a user is compared and analyzed, and provided in a customized type.

Then, a second operation (S200) of receiving and collecting information about the user from the user terminal to analyze the user information is performed. Personal competency information of the user including certification information and extracurricular activity information of the user is input from the user through the user terminal. The second operation (S200) includes analyzing personal information of the user (a prospective student). By doing so, personal information is input from the user and analyzed to analyze a field for which the user is suitable in terms of an interest or aptitude.

The personal information is input to analyze aptitude based on current competency of the user such as certification information, extracurricular activity information (overseas training, foreign languages, volunteering services, and major activities), and foreign language test scores each held prior to admission.

Accordingly, through the second operation (200), the personal competency information of the user is input, and based on this, the platform server recommends department information suitable for the user.

To do so, a third operation (S300) includes comparing the department information analysis data stored in the first operation to the user's personal competency information input in the second operation to generate and provide information on a plurality of recommended departments.

The third operation (S300) described above is an operation for recommending a department suitable for the user based on the personal competency information input by the user. Competencies and a field of interest of the user are checked, and then, matched with the department information analysis data to recommend departments suitable for the user. At this time, a plurality of relevant departments are recommended to be selected by the user.

A fourth operation (S400) includes recommending departments based on information of the recommended departments for the user, which has been analyzed in the third operation, and a correlation between a plurality of the recommended departments recommended herein is illustrated to be provided to the user terminal.

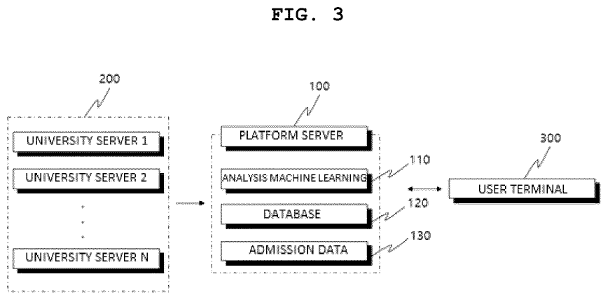

As shown in FIGS. 3 to 6, this is to provide similarity information for the recommended departments together through visualization so that the user may check information for corresponding departments at one view.

A fifth operation (S500) includes, when one of the departments recommended in the fourth operation is selected through the user terminal, analyzing comparative analysis data in correspondence with a resultant value of comparing the department information analysis data corresponding to the selected department with the personal competency information of the user.

That is, in the fifth operation (S500), when the user selects one of the plurality of recommended departments, the platform server analyzes a degree to which the user is satisfied with the selected department based on the selected department and the personal competency information of the user, and provides comparative analysis data. The comparative analysis data corresponds to an analysis value obtained by analyzing a degree to which the selected department matches individual interests and current competency information based on comparison with the personal competency information.

By doing so, the user may check a degree of matching of the department selected by the user among the plurality of recommended departments. At this time, the user may select another department among the plurality of recommended departments to check again whether the another department matches competency of the user.

For example, when the personal competency information shows that a foreign language interest or proficiency is analyzed at 80% based on percentage criteria, and a department selected by the user among the recommended departments requires foreign language proficiency of 90% or higher, the user may understand that competency of the user is currently insufficient in foreign language proficiency corresponding to the selected department. In addition, a degree of satisfaction may be also checked by analyzing a degree of interest of the user and interest information required by the corresponding department through analysis values of interests.

Accordingly, in the present disclosure, department information may be recommended by inputting personal competency information based on department information analysis data, thereby verifying department information suitable for a user.

Finally, a sixth operation (S600) is configured to include generating admission prediction data. In the present disclosure, along with provision of major information of the user, admission prediction data is provided based on existing admission data including information about desired departments, admitting departments, and selected departments of existing admitted students. The admission prediction data is provided by analyzing current personal competency information of the user based on admission data of the existing admitted students, and then, analyzing additionally needed information such as objective scores (test scores, school grades, etc.) or information on extracurricular activity information, and certificates, and desired department information, information about admitting departments, and information about a department ultimately selected from the admitting departments each based on personal competency information of the existing admitted students. Therefore, the user may reasonably and satisfactorily select a university and a major, based on the admission prediction data provided through the user terminal.

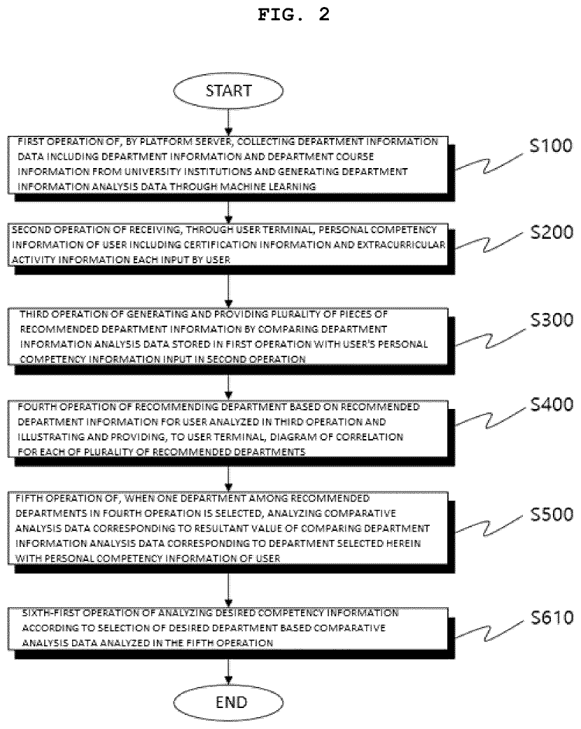

FIG. 2 is a flowchart illustrating another embodiment of a method of recommending a department through personal competency analysis according to the present disclosure.

As described above with reference to FIG. 1, after recommending the department information suitable for a user through the process in the first to fifth operations, a sixth-first operation (S610) of analyzing desired competency information for analyzing and providing competency information needed for a desired department of the user is further included.

The desired competency information is provided by analyzing an insufficient competency information value with respect to a department desired by the user based on current personal competency information. For example, when a corresponding department requires an interest or competency in humanities to be 70% or higher based on percentage criteria, whether this requirement is satisfied is determined and provided based on a value of personal competency information of the user. At this time, annual reading volume information may be input as the personal competency information, and reading genres may be analyzed to convert competency information of the user about humanities into a percentage to generate and provide comparative data.

FIG. 3 is a whole configuration diagram of a system configured to implement a method of recommending a department through personal competency analysis according to the present disclosure.

In the present disclosure, a platform server 100 configured to generate and store department information analysis data by collecting information about educational institutions, a university server 200 configured to provide educational information of educational institutions collected by the platform server 100, and a user terminal 300 configured to receive personal competency information from a user are included.

In addition, the platform server 100 includes analysis machine learning 110 configured to collect department information from the university server 200 and generate department information analysis data, and a database 120 configured to store the department information analysis data generated herein.

The analysis machine learning 110 collects and analyzes, based on language, relevant information such as department information of each university, major information corresponding to a department, corresponding professor information, thesis information, employment information, admission information, employment information, etc. and analyze a relationship corresponding thereto to thereby generate department information analysis data in correspondence with a result value. As described with reference to FIG. 3, visualization information according to a similarity relationship diagram is generated and provided together.

In addition, the analysis machine learning 110 performs a function of recommending department information by matching personal competency information input from the user terminal 100 based on the department information analysis data.

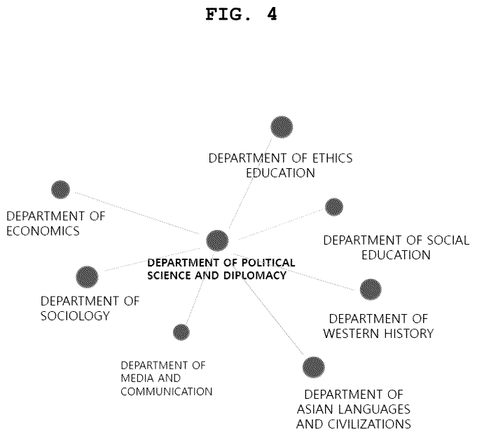

FIG. 4 is a diagram illustrating a correlation between departments as an embodiment of the method of recommending a department through personal competency analysis according to the present disclosure.

As described above, in the present disclosure, a correlation between majors of a corresponding university institution is analyzed for visualization. By providing visualization information of the correlation to users, a similarity between departments may be easily checked. FIG. 4 is a detailed diagram illustrating visualization of the department information of FIG. 3.

As shown in FIG. 4, with reference to the Department of Political Science and Diplomacy, a correlation between the Department of Ethics Education, the Department of Economics, the Department of Social Education, the Department of Sociology, the Department of Media and Communication, the Department of Western History, and the Department of Asian Languages and Civilizations is visualized and provided.

Accordingly, information of such analysis may be provided to a user terminal so that a user may easily check similarity information of the departments. Department information that may be selected based on information provided herein may be checked at one view.

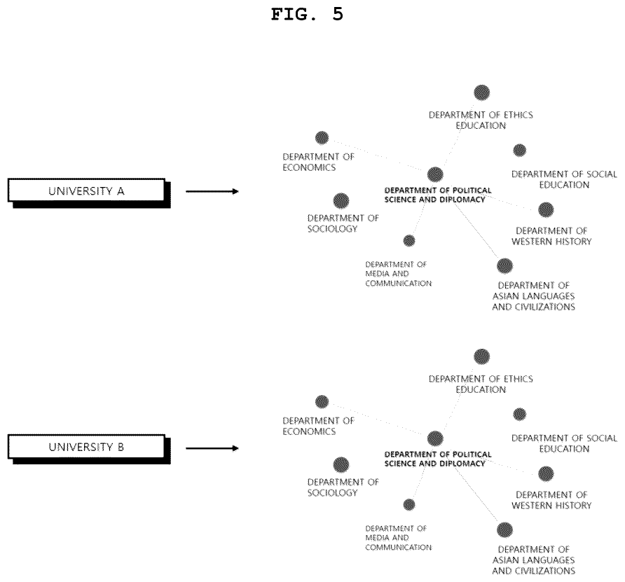

FIG. 5 is a diagram illustrating a correlation between departments for respective schools in the method of recommending a department through personal competency analysis according to the present disclosure.

When a user desires admission to University A, the platform server 100 provides the user with information on relevant departments (recommended departments) with reference to the University A in the fourth operation described above. In addition, when the user selects a department at University B which is another university, in addition to the desired University A, information of the department at the University B is generated through department information analysis data to be visually accessed, and upon selection by the user, the department information of the corresponding university is provided.

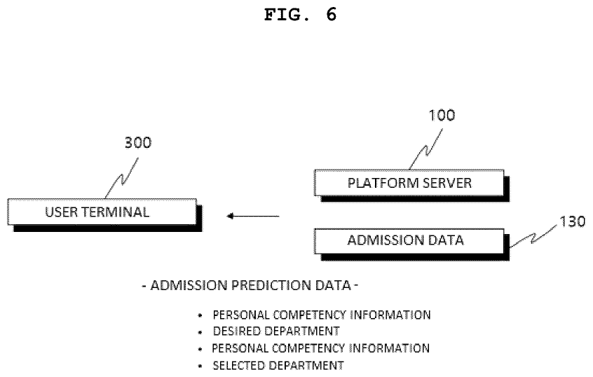

FIG. 6 illustrates an example of admission prediction data in the method of recommending a department through personal competency analysis according to the present disclosure.

As described above, in the present disclosure, recommended department information is provided based on personal competency information of a user and, together with this, admission prediction data is provided. The admission prediction data in the present disclosure is generated and provided according to analysis performed based on insufficient or necessary competency information in comparison of personal competency information of the user with competency information of other users previously successfully admitted to universities, admitting department information according to a department desired by the user, and information about a department ultimately selected by the user.

Accordingly, in the present disclosure, a user may select a university and a major to achieve highly satisfied admission based on college admission prediction data.

In the present disclosure configured as described above, there is such an advantage that, to promote efficient selection of departments for admission to middle schools, high schools, or universities by prospective students, customized information such as competencies, interests, and desired career paths of the prospective students may be analyzed and department information that aligns with career or major suitability may be recommended, thereby allowing the prospective students to efficiently select career directions with high satisfaction through the competency analysis.

In addition, the present disclosure has an effect of visualizing similarity information of department information for respective schools, thereby allowing prospective students to easily check the similarity information and plan admission strategies accordingly.

Particularly, the present disclosure has an advantage of providing admission prediction data of a user based on admission data, resultantly allowing to determine an optimized direction for admission.

While the present disclosure has been described and illustrated with reference to embodiments for illustrating the principles of the present disclosure, the present disclosure is not limited to the configurations and operations set forth herein. Rather, it may be understood by one of ordinary skill in the art that various changes and modifications thereof may be made without departing from the spirit and scope of the present disclosure. Accordingly, it is to be appreciated that all appropriate changes, equivalents, and substitutes are encompassed in the present disclosure.

### Description of Reference Numerals

100: Platform server
110: Analysis machine learning
120: Database
130: Admission data
200: University server
300: User terminal

What is claimed is:

1. A method of recommending a department through personal competency analysis using a department recommendation system configured to comprise: a platform server configured to generate department information analysis data through machine learning after collecting department information of a plurality of university institutions, analyze personal competency information of a user by comparing the department information analysis data with the personal competency information input by the user, generate and provide recommended department information based on the personal competency information, and generate desired competency information by comparing the personal competency information of the user and the department information analysis data; a university server configured to provide department information data comprising department information and department course information of a corresponding university to allow the platform server to collect the department information; and a user terminal configured to receive, from the user, an input of the personal competency information of the user to provide the personal competency information to the platform server, the method comprising:
a first operation of, by the platform server, collecting department information data comprising department information and department course information from the plurality of the university institutions, and generating and storing department information analysis data through machine learning;
a second operation of receiving personal competency information comprising certification information and extracurricular activity information, the personal competency information being input by the user through the user terminal;
a third operation of generating at least one piece of university recommended department information by comparing the department information analysis data stored in the first operation with the personal competency information input by the user in the second operation;
a fourth operation of illustrating and providing, to the user terminal, a diagram of a correlation between a plurality of recommended departments based on the at least one piece of university recommended department information generated for the user in the third operation;
a fifth operation of, when one department among the plurality of recommended departments in the fourth operation is selected, generating comparative analysis data corresponding to a resultant value of comparing the department information analysis data corresponding to the selected department with the personal competency information of the user; and
a sixth operation of generating admission prediction data by comparing the comparative analysis data analyzed in the fifth operation with admission data of university admitted students, the admission data being stored in the platform server, and then, providing the generated admission prediction data to the user terminal.

2. The method of claim 1, wherein with respect to the admission prediction data, personal competency information corresponding to existing university admission, and information about desired departments, accepted departments, and selected departments are generated and provided to the user terminal.
